(19) United States
(12) Patent Application Publication
(10) Pub. No.: US 2012/0274536 A1
(43) Pub. Date: Nov. 1, 2012

(54) MULTIPLE-INPUT MULTIPLE-OUTPUT ANTENNA

(75) Inventor: CHUN-JUI PAN, Tu-Cheng (TW)

(73) Assignee: HON HAI PRECISION INDUSTRY CO., LTD., Tu-Cheng (TW)

(21) Appl. No.: 13/457,410

(22) Filed: Apr. 26, 2012

(30) Foreign Application Priority Data
Apr. 27, 2011 (CN) 201110107390.9

(51) Int. Cl. H01Q 21/00

(52) U.S. Cl. 343/853

(57) ABSTRACT

A Multiple-Input Multiple-Output (MIMO) antenna on a substrate includes first and second antennas defined in axial symmetry, a coupling portion, and a grounding portion. The substrate includes a first surface and an opposite second surface. Each of the antennas includes a feeding portion, a radiating portion, and a matching portion. The feeding portion feeds electromagnetic signals to the antenna. The radiating portion radiates the electromagnetic signals, and is in a meandering “S” pattern. A length of the radiating portion is substantially equal to a quarter wavelength of the electromagnetic signals. The matching portion implements impedance matching between the feeding portion and the radiating portion. The coupling portion is located between the first antenna and the second antenna and is serpentine shape. A length of the coupling portion is substantially equal to a half wavelength of the electromagnetic signals. The grounding portion is located on both the first and second surface.

### BACKGROUND

1. Technical Field

The present disclosure relates to antennas, and more particularly to a multiple-input multiple-output (MIMO) antenna.

2. Description of Related Art

Because an antenna located on a printed circuit board (PCB) may be too close to other antenna(s) due to small dimensions of the PCB, it is hard to enhance isolation between antennas. Isolation can be improved by increasing the number of slots or dividing an antenna using a grounding portion; however, both ways increase the dimensions of the antenna. Accordingly, it is important to provide an antenna that will fit in a smaller PCB with enhanced isolation and improved radiating performance.

### BRIEF DESCRIPTION OF THE DRAWINGS

Many aspects of the exemplary embodiments can be better understood with reference to the following drawings. The components in the drawings are not necessarily drawn to scale, the emphasis instead being placed upon clearly illustrating the principles of the exemplary embodiments. Moreover, in the drawings, all the views are schematic, and like reference numerals designate corresponding parts throughout the several views.

FIG. 1 shows a front view of a first embodiment of a first MIMO antenna in accordance with the present disclosure.

FIG. 2 shows a back view of the first MIMO antenna shown in FIG. 1 in accordance with the present disclosure.

FIG. 3 shows a schematic view of the first embodiment of a type of a matching circuit included in a matching portion in accordance with the present disclosure.

FIG. 4 shows a schematic view of exemplary dimensions of a first surface of the first MIMO antenna shown in FIG. 1 in accordance with the present disclosure.

FIG. 5 shows a schematic view of exemplary dimensions of a second surface of the first MIMO antenna shown in FIG. 1 in accordance with the present disclosure.

FIG. 6 shows exemplary return loss and isolation measurement for the first MIMO antenna shown in FIG. 1 in accordance with the present disclosure.

FIG. 7 shows a front view of a second embodiment of a second MIMO antenna in accordance with the present disclosure.

FIG. 8 shows a back view of the second MIMO antenna shown in FIG. 7 in accordance with the present disclosure.

FIG. 9 shows a schematic view of exemplary dimensions of a first surface of the second MIMO antenna shown in FIG. 7 in accordance with the present disclosure.

FIG. 10 shows a schematic view of exemplary dimensions of a second surface of the second MIMO antenna shown in FIG. 7 in accordance with the present disclosure.

FIG. 11 shows exemplary return loss and isolation measurement for the second MIMO antenna shown in FIG. 7 in accordance with the present disclosure.

FIG. 12 shows a front view of a third embodiment of a third MIMO antenna in accordance with the present disclosure.

FIG. 13 shows a back view of the third MIMO antenna shown in FIG. 12 in accordance with the present disclosure.

FIG. 14 shows a schematic view of exemplary dimensions of a radiating portion and a third coupling portion of the third MIMO antenna shown in FIG. 12 in accordance with the present disclosure.

FIG. 15 shows exemplary return loss and isolation measurement for the third MIMO antenna shown in FIG. 12 in accordance with the present disclosure.

FIG. 16 shows a front view of a fourth embodiment of a fourth MIMO antenna in accordance with the present disclosure.

FIG. 17 shows a back view of the fourth MIMO antenna shown in FIG. 16 in accordance with the present disclosure.

FIG. 18 shows a schematic view of exemplary dimensions of a radiating portion and a fourth coupling portion of the fourth MIMO antenna shown in FIG. 16 in accordance with the present disclosure.

FIG. 19 shows exemplary return loss and isolation measurement for the fourth MIMO antenna shown in FIG. 16 in accordance with the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

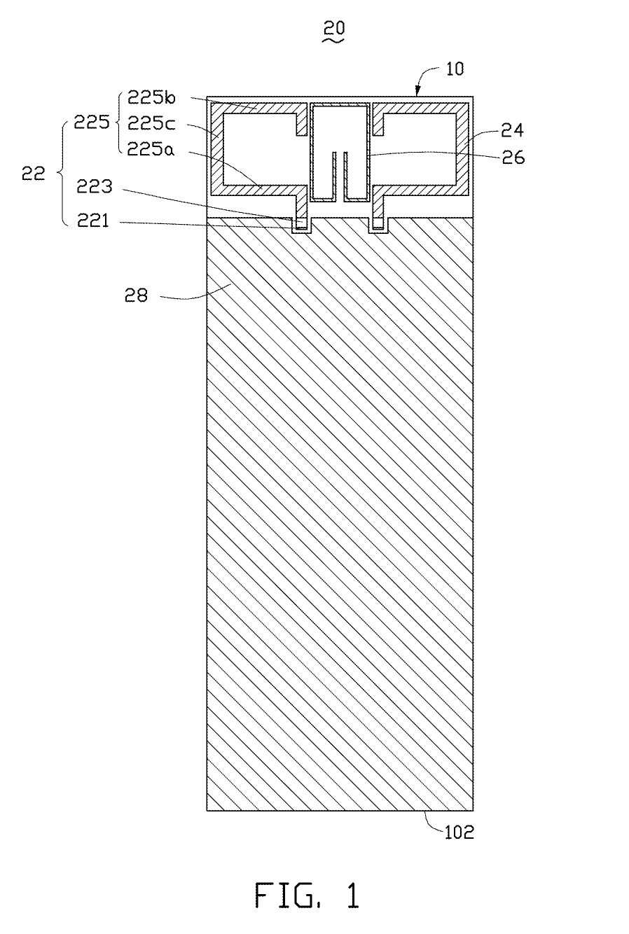

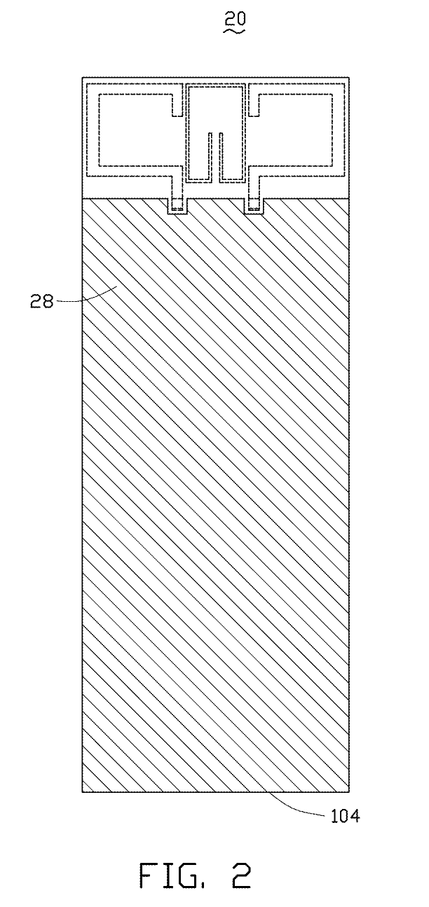

FIGS. 1 and 2 respectively show front and back views of a first embodiment of a first multiple-input multiple-output (MIMO) antenna 20 in accordance with the present disclosure.

In the exemplary embodiment, the first MIMO antenna 20 is located on a substrate 10. The substrate 10, a printed circuit board (PCB), includes a first surface 102 (shown in FIG. 1) and a second surface 104 (shown in FIG. 2) opposite to the first surface 102. The first MIMO antenna 20 includes a first antenna 22 and a second antenna 24 defined in axial symmetry, a first coupling portion 26 and a grounding portion 28.

The first antenna 22 includes a feeding portion 221, a matching portion 223 and a radiating portion 225. The radiating portion 225 includes a first radiating part 225a, a second radiating part 225b and a third radiating part 225c. The following descriptions are presented using the first antenna 22 as the first antenna 22 has a structure symmetrical structure to the second antenna 24.

The feeding portion 221 is located on the first surface 102 of the substrate 10 and serves as a feeding portion through which electromagnetic wave signals are fed to the first antenna 22.

The radiating portion 225 is located on the first surface 102 of the substrate 10 and radiates the electromagnetic signals from the feeding portion 221. In the exemplary embodiment, the first radiating part 225a, the second radiating part 225b and the third radiating part 225c are connected in series and collectively form a meandering “S” pattern. Each of the first radiating part 225a and the second radiating part 225b is in the shape of an “L” while the third radiating part 225c is elongated. In the exemplary embodiment, the radiating portion 225 is about λ/4 in length, where the λ is wavelength of the electromagnetic signals.

In the exemplary embodiment, one end of the first radiating part 225a is electrically connected to the matching portion 223 while the other end of the first radiating part 225a is perpendicularly connected to the third radiating part 225c. The second radiating part 225b is perpendicularly connected to third radiating part 225c while the first radiating part 225a and the second radiating part 225b have the same crooked patterns.

The matching portion 223 is located on the first surface 102 of the substrate 10 and used for impedance matching between the feeding portion 221 and the radiating portion 225. In the exemplary embodiment, one end of the matching portion 223 is electrically connected to the feeding portion 221 and the other end is electrically connected to the first radiating part 225a of the radiating portion 225. The matching portion is composed of various types of LC matching circuits, such as L-type LC matching circuits, π-type LC matching circuits, and T-type LC matching circuits, for example.

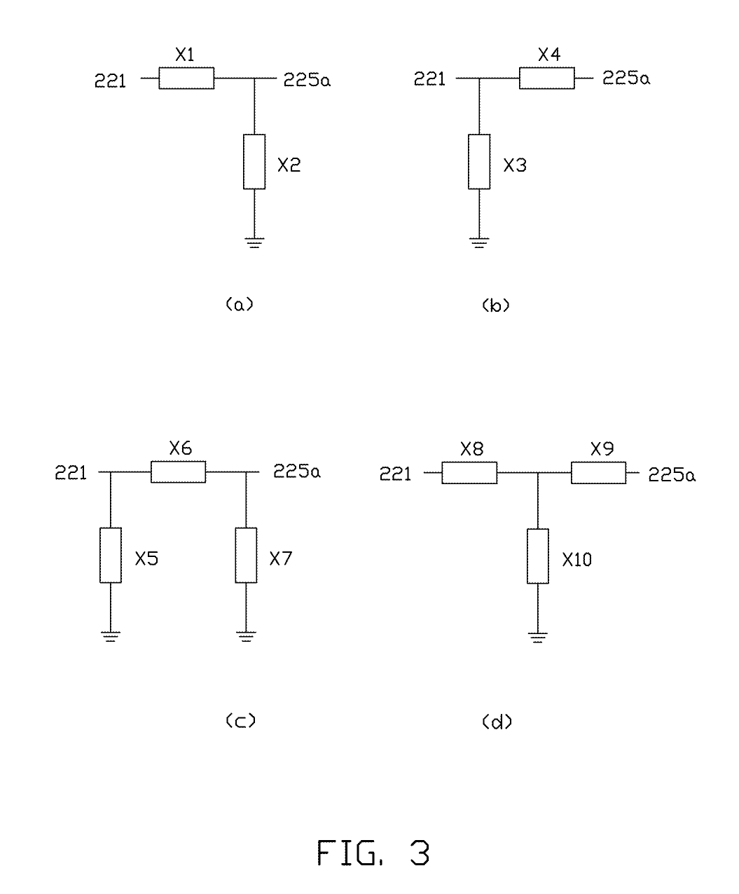

FIG. 3 shows a schematic view of various types of matching circuits involved in the matching portion 223. As shown in FIG. 3, sections, (a) and (b) shows L-type LC matching circuits, section (c) shows a π-type LC matching circuit and section (d) shows a T-type LC matching circuit. In the exemplary embodiment, X1-X10 can be inductance components or capacitance components. Impedance matching is achieved by selecting various types of LC matching circuits through calculating impedance of the first MIMO antenna 20, thereby enhancing radiating performance of the first MIMO antenna 20.

Referring to FIGS. 1 and 2, the first coupling portion 26 is located between and separated from the first antenna 22 and the second antenna 24 to improve isolation between the first antenna 22 and the second antenna 24. In the exemplary embodiment, the first coupling portion 26 forms a meandering pattern and is about λ/2 in length and, therefore, a portion of currents of the first antenna 22 (or the second antenna 24) under a specific frequency is coupled to the first coupling portion 26 through electromagnetic coupling while resonance for the first coupling portion 26 is generated. Thus, currents on the second antenna 24 from the first antenna 22 through direct coupling and currents on the first antenna 22 from the second antenna 24 through direct coupling are greatly reduced to improve isolation between the first antenna 22 and the second antenna 24.

Theoretically, the present features are substantially different from the current method dividing antennas using a grounding portion. The current method outwardly radiates antenna patterns using the grounding portion to reduce radiations between antennas and decreasingly radiate electromagnetic wave energy from one antenna to another antenna, thus improving antenna isolation. In the present disclosure, the first coupling portion 26 is located between two antennas and designed in a proper length. Therefore, a portion of currents of the first antenna 22 and the second antenna 24 under a specific frequency is coupled to the first coupling portion 26 and resonance for the coupling portion 26 is generated. Accordingly, less current from one antenna can be fed to the other antenna in the near field through electromagnetic coupling to reach maximum isolation. As mentioned above, the present disclosure is obviously different than the current method.

In addition, the current method improves antenna isolation by adding slots to an antenna. Antenna resonance is generated within the slots with the antenna under a specific frequency so that currents of a grounding portion of the antenna are restricted around the slots. Therefore, less current is fed from the antenna to another via the grounding portion, improving the antenna isolation. However, the two antennas are too close that isolation is not improved even if slots are added, which can only enhance current coupling of the grounding portion. Regarding the present disclosure, defining the first coupling portion 26 with a preset length between the antenna 22 and the antenna 24 can reduce near field coupling between the antenna 22 and the antenna 24 and better current coupling of the grounding portion 28. Accordingly, the present disclosure can improve antenna isolation on the basis of limited dimensions, which is better than the current method.

In the exemplary embodiment, the first coupling portion 26 is located on the first surface 102 of the substrate 10 and defined in axial symmetry with the second coupling portion 26, and the first and second antennas 22 and 24 share the same axis of symmetry. The first coupling portion 26 comprises an elongated strip with a first open end and a second open end. The elongated strip is formed along a contour of a rectangle with a gap at the center of one side edge of the rectangle while the first and second open ends inwardly extends from the gap to the inner of the rectangle. The extended direction in which the first and second open ends extend is parallel to the axis of symmetry of the first coupling portion 26. It is noted that the first coupling portion 26 can be any type formed in various shapes of meandering patterns and is λ/2 in length.

The grounding portion 28 is located on the first surface 102 and the second surface 104 of the substrate 10.

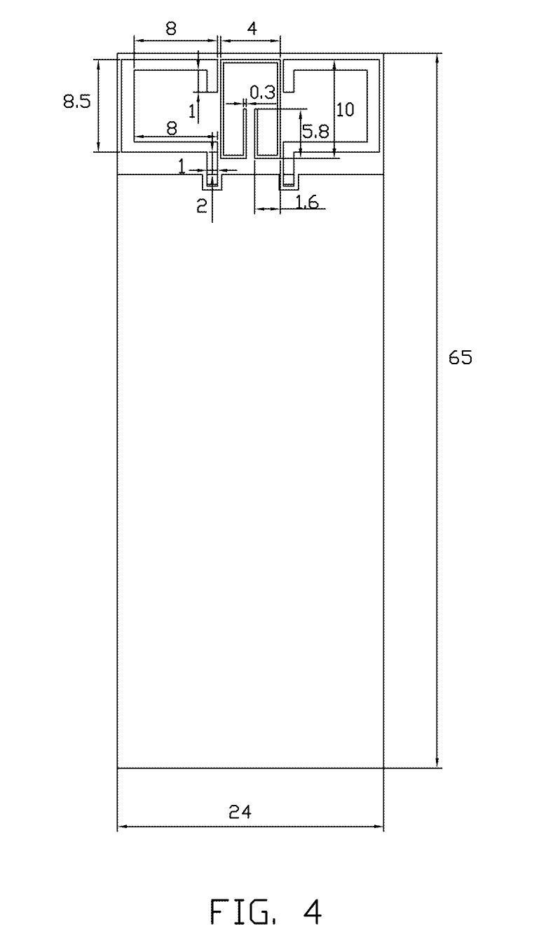

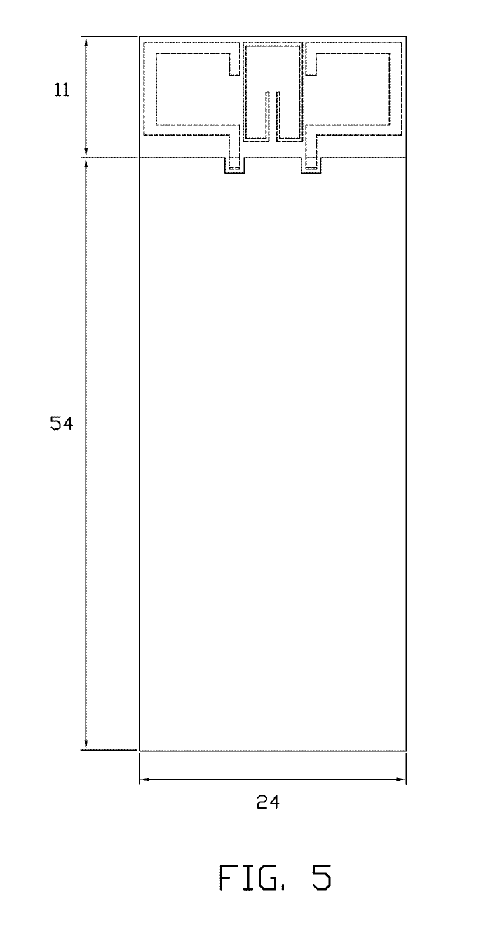

FIG. 4 shows exemplary dimensions of the first surface 102 of the first MIMO antenna 20. FIG. 5 shows exemplary dimensions of the second surface 104 of the first MIMO antenna 20.

In the exemplary embodiment, the length, width and thickness of the substrate 10 are 65 mm, 24 mm and 1 mm, respectively. The length and width of the grounding portion 28 on the first surface 102 and the second surface 104 are 54 mm and 24 mm, respectively. The length and width of the first radiating part 225a are 10 mm and 1 mm, respectively. The length and width of the first radiating part 225b are 9 mm and 1 mm, respectively. The length and width of the first radiating part 225c are 8.5 mm and 1 mm, respectively. The length and width of the first coupling portion 26 are 37 mm and 1 mm, respectively.

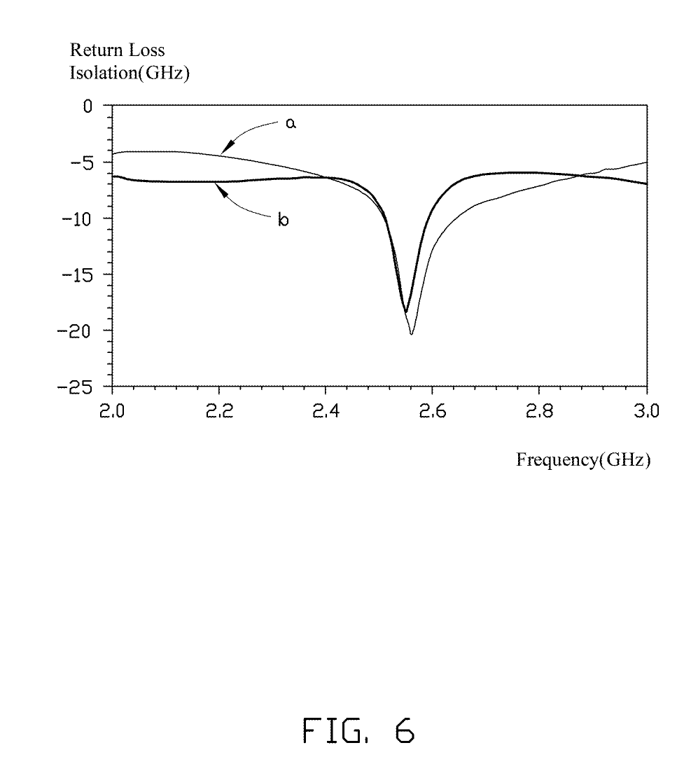

FIG. 6 shows exemplary return loss and isolation measurement for the first MIMO antenna 20. As shown in FIG. 6, curve a represents the return loss for the first MIMO antenna 20 while curve b represents the isolation for the first MIMO antenna 20.

The present disclosure enables the first MIMO antenna 20 to cover radio frequency bands 2.5 GHz-2.6 GHz under Long Term Evolution (LTE) over which return loss attenuation is less than −10 decibels (dB), which is applicable to communication standards, provides better isolation and greatly ameliorates radiating performance of the first MIMO antenna 20.

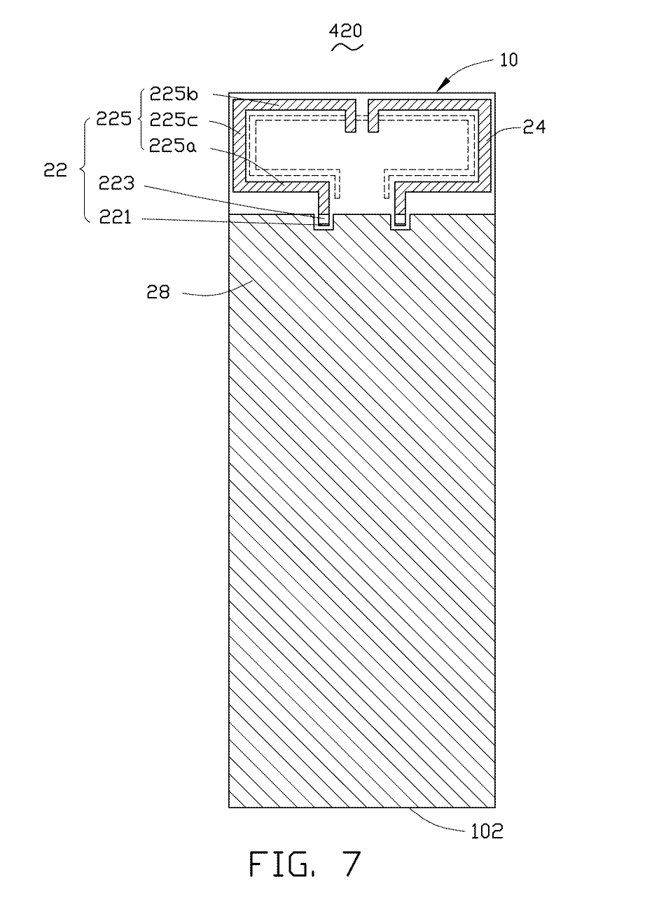

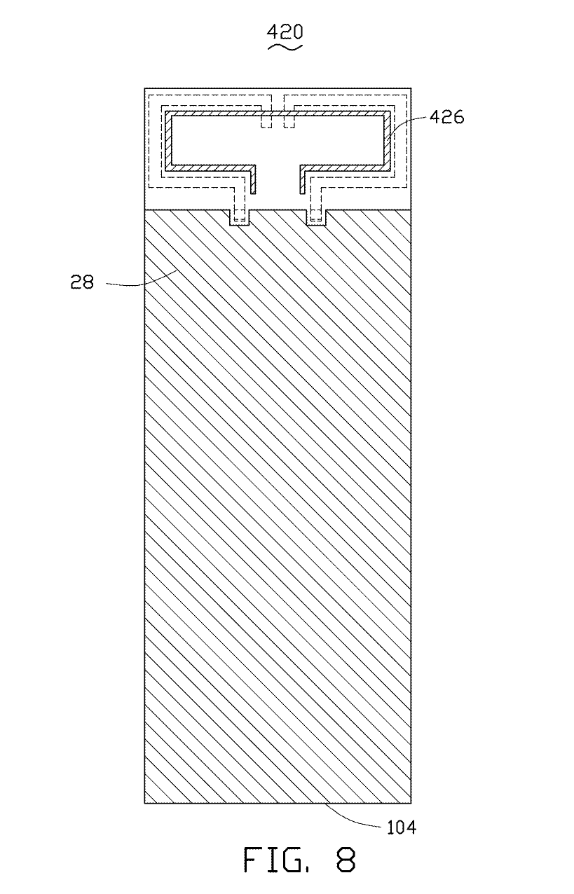

FIGS. 7 and 8 respectively show a front view and a back view of a second embodiment of a second MIMO antenna 420 in accordance with the present disclosure. In the exemplary embodiment, the second MIMO antenna 420 differs from the first MIMO antenna 20 shown in FIGS. 1 and 2 that the first coupling portion 26 is moved from the first surface 102 to the second surface 104, the shape of the first coupling portion 26 is adjusted to form a second coupling portion 426 and dimensions of the radiating portion 225 are changed.

The second MIMO antenna 420 includes a first antenna 22 and a second antenna 24 defined in axial symmetry, a second coupling portion 426 and a grounding portion 28. The first antenna 22 includes a feeding portion 221, a matching portion 223 and a radiating portion 225. The radiating portion 225 includes a first radiating part 225a, a second radiating part 225b and a third radiating part 225c.

In the exemplary embodiment, the second coupling portion 26 of the second MIMO antenna 420 is located, on the second surface 104, between and separated from the first antenna 22 and the second antenna 24 to improve isolation of the second MIMO antenna 420. The second coupling portion 426 forms a meandering pattern and is about λ/2 in length and, therefore, a portion of currents of the first antenna 22 (or the second antenna 24) under a specific frequency is coupled to the second coupling portion 426 while resonance for the second coupling portion 426 is generated. Thus, currents on the second antenna 24 (or the first antenna 22) are greatly reduced to improve isolation of the second MIMO antenna 420.

In the exemplary embodiment, the second coupling portion 426 is defined in axial symmetry and share the same axis of symmetry with the first and second antennas 22 and 24. In addition, a projection of the second coupling portion 426 projected on the first surface 102 of the substrate 10 overlaps the radiating portion 225.

In the exemplary embodiment, the second coupling portion 426 comprises an elongated strip with a first open end and a second open end. The elongated strip forms a rectangle with a gap at the center of one side edge of the rectangle while the first and second open ends outwardly extends from the gap to the outer of the rectangle. The extended direction is parallel to the axis of symmetry of the second coupling portion 426. It is noted that the second coupling portion 426 can be any type of meandering patterns and is λ/2 in length.

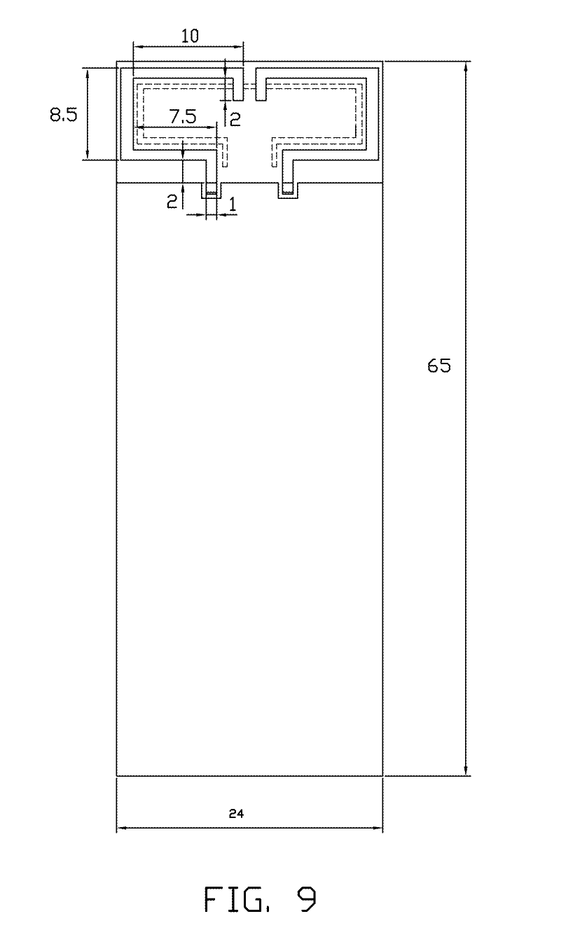

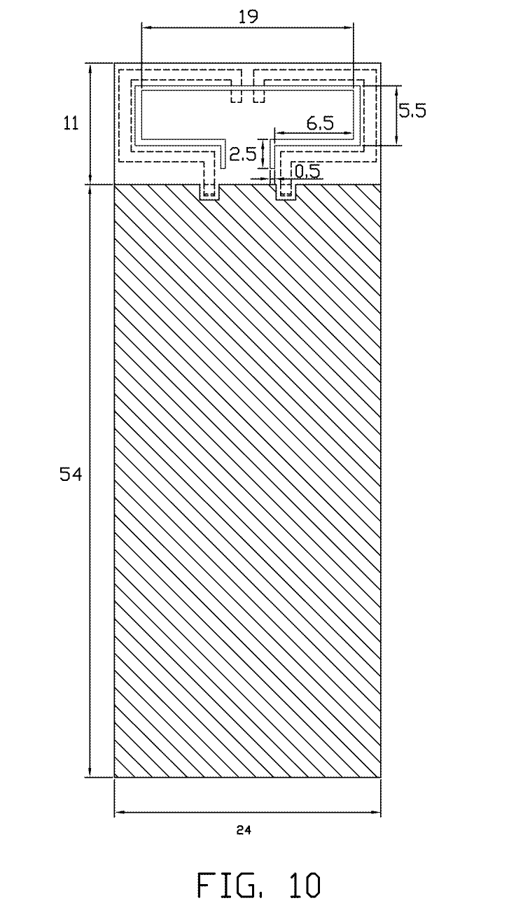

FIG. 9 shows a schematic view of exemplary dimensions of the first surface 102 of the second MIMO antenna 420. FIG. 10 shows a schematic view of exemplary dimensions of the second surface 104 of the second MIMO antenna 420.

In the exemplary embodiment, the length, width and thickness of the substrate 10 are 65 mm, 24 mm and 1 mm, respectively. The length and width of the grounding portion 28 on the first surface 102 and the second surface 104 are 54 millimeters (mm) and 24 mm, respectively. The length and width of the first radiating part 225a are 10 mm and 1 mm, respectively. The length and width of the first radiating part 225b are 12 mm and 1 mm, respectively. The length and width of the first radiating part 225c are 8.5 mm and 1 mm, respectively. The length and width of the second coupling portion 426 are 48 mm and 0.5 mm, respectively.

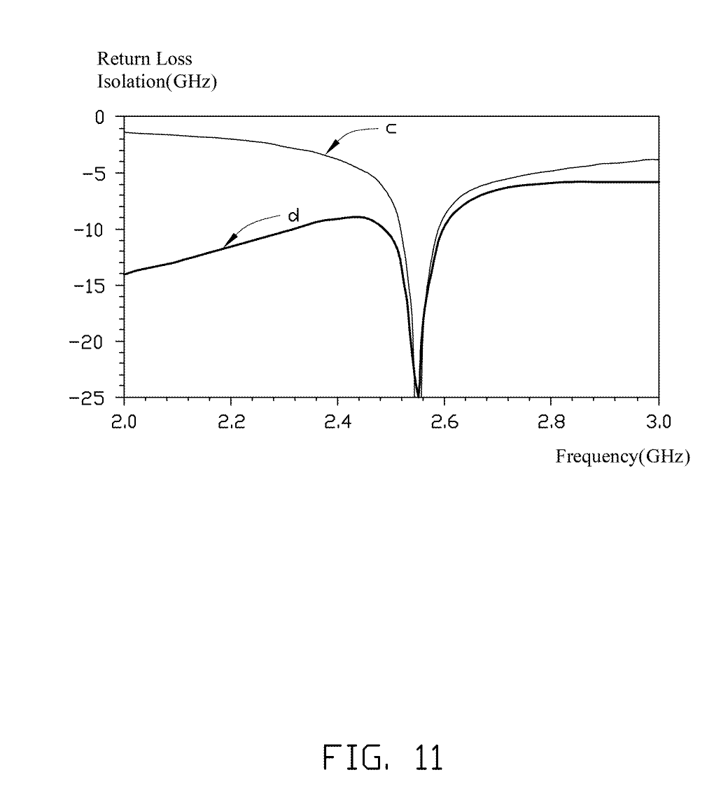

FIG. 11 shows exemplary return loss and isolation measurement for the second MIMO antenna 420. As shown in FIG. 11, curve c represents the return loss for the second MIMO antenna 420 while curve b represents the isolation for the second MIMO antenna 420. The present disclosure enables the second MIMO antenna 420 to cover radio frequency bands 2.5 GHz-2.6 GHz under LTE over which return loss attenuation is less than −10 decibels (dB), which is applicable to communication standards, provides better isolation and greatly ameliorates radiating performance of the second MIMO antenna 820.

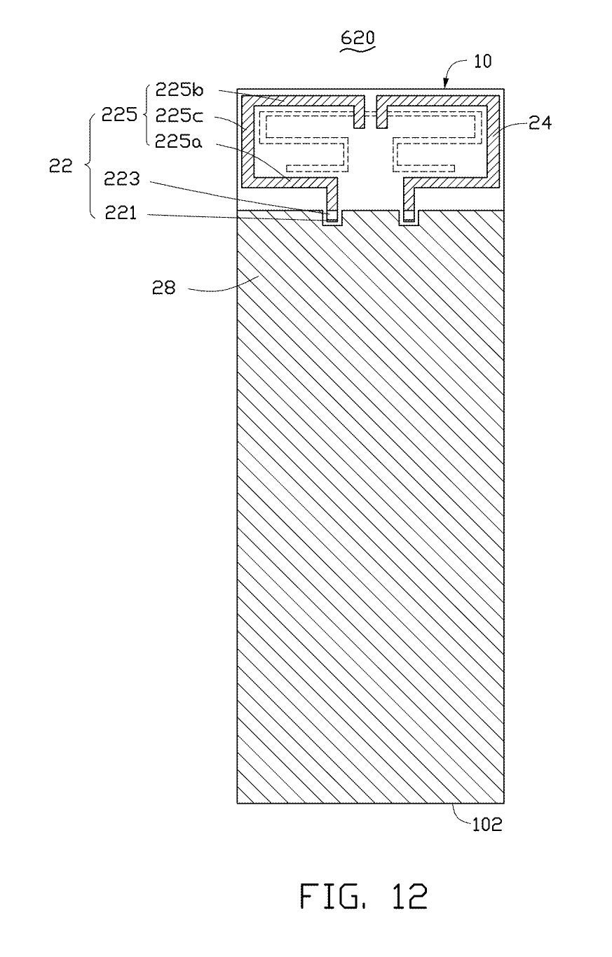

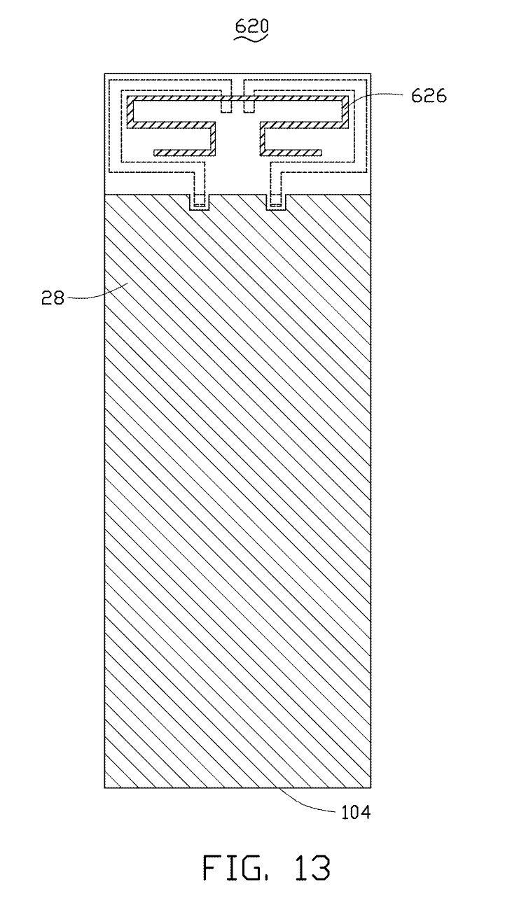

FIGS. 12 and 13 respectively show a front view and a back view of a third embodiment of a third MIMO antenna 620 in accordance with the present disclosure. In the exemplary embodiment, the third MIMO antenna 620 differs from the first MIMO antenna 20 shown in FIGS. 1 and 2 that the first coupling portion 26 is moved from the first surface 102 to the second surface 104, the shape of the first coupling portion 26 is adjusted to form a third coupling portion 626 and dimensions of the radiating portion 225 are changed.

The third MIMO antenna 620 includes a first antenna 22 and a second antenna 24 defined in axial symmetry, a third coupling portion 626 and a grounding portion 28. The first antenna 22 includes a feeding portion 221, a matching portion 223 and a radiating portion 225. The radiating portion 225 includes a first radiating part 225a, a second radiating part 225b and a third radiating part 225c.

In the exemplary embodiment, the third coupling portion 626 of the third MIMO antenna 620 is located, on the second surface 104, between and separated from the first antenna 22 and the second antenna 24 to improve isolation of the third MIMO antenna 620. The third coupling portion 626 forms a meandering pattern and is about λ/2 in length and, therefore, a portion of currents of the first antenna 22 (or the second antenna 24) under a specific frequency is coupled to the third coupling portion 626 while resonance for the third coupling portion 626 is generated. Thus, currents on the second antenna 24 (or the first antenna 22) are greatly reduced to improve isolation of the third MIMO antenna 620.

In the exemplary embodiment, the third coupling portion 426 is defined in axial symmetry and share the same axis of symmetry with the first and second antennas 22 and 24. In addition, a projection of the third coupling portion 626 projected on the first surface 102 of the substrate 10 overlaps the radiating portion 225.

In the exemplary embodiment, the third coupling portion 626 comprises an elongated strip with a first open end and a second open end. The elongated strip forms a rectangle with a gap defined at the center of one side of the rectangle and the first and second open ends outwardly extends from the gap to the outer of the rectangle in a first direction and then outwardly extends in a second direction. The first direction is parallel to the axis of symmetry of the third coupling portion 626 while the second direction is perpendicular to the axis of symmetry of the third coupling portion 626. It is noted that the third coupling portion 626 is any type of meandering patterns and is about λ/2 in length, where the λ is wavelength of the electromagnetic signals.

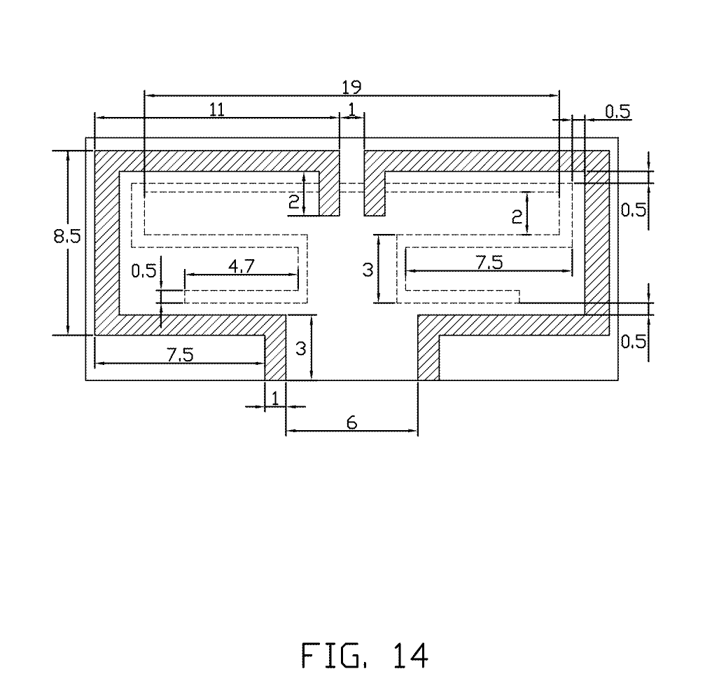

FIG. 14 shows a schematic view of exemplary dimensions of the radiating portion 225 and the third coupling portion 626 of the third MIMO antenna 620.

In the exemplary embodiment, the length and width of the first radiating part 225a are 9.5 mm and 1 mm, respectively. The length and width of the first radiating part 225b are 12 mm and 1 mm, respectively. The length and width of the first radiating part 225c are 8.5 mm and 1 mm, respectively. The length and width of the third coupling portion 626 are 54.4 mm and 0.5 mm, respectively.

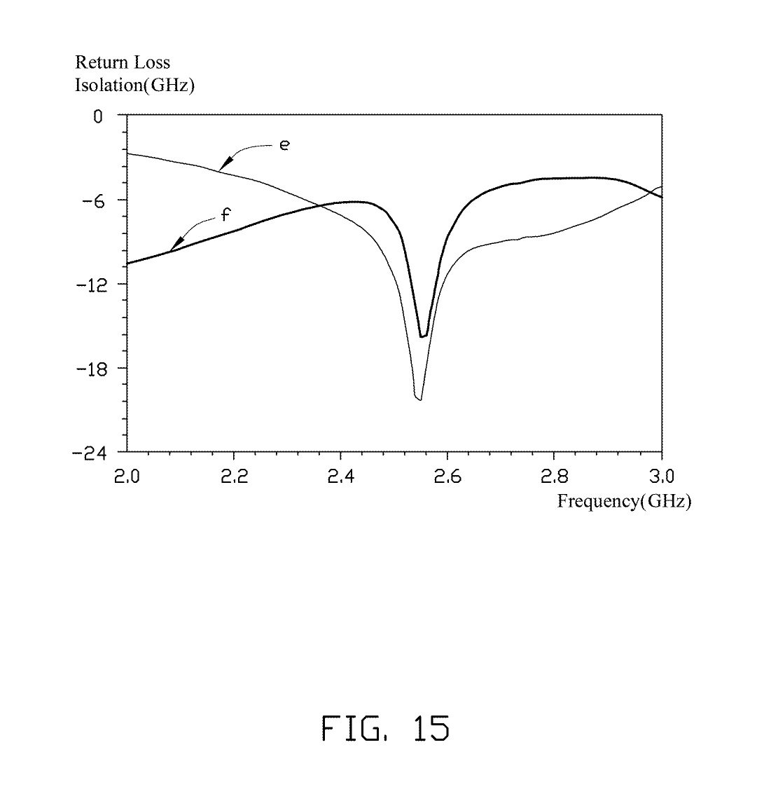

FIG. 15 shows exemplary return loss and isolation measurement for the third MIMO antenna 620. As shown in FIG. 15, curve e represents the return loss for the third MIMO antenna 620 while curve f represents the isolation for the third MIMO antenna 620. The present disclosure enables the third MIMO antenna 620 to cover radio frequency bands 2.5 GHz-2.6 GHz under LTE over which return loss attenuation is less than −10 decibels (dB), which is applicable to communication standards, provides better isolation and greatly ameliorates radiating performance of the third MIMO antenna 620.

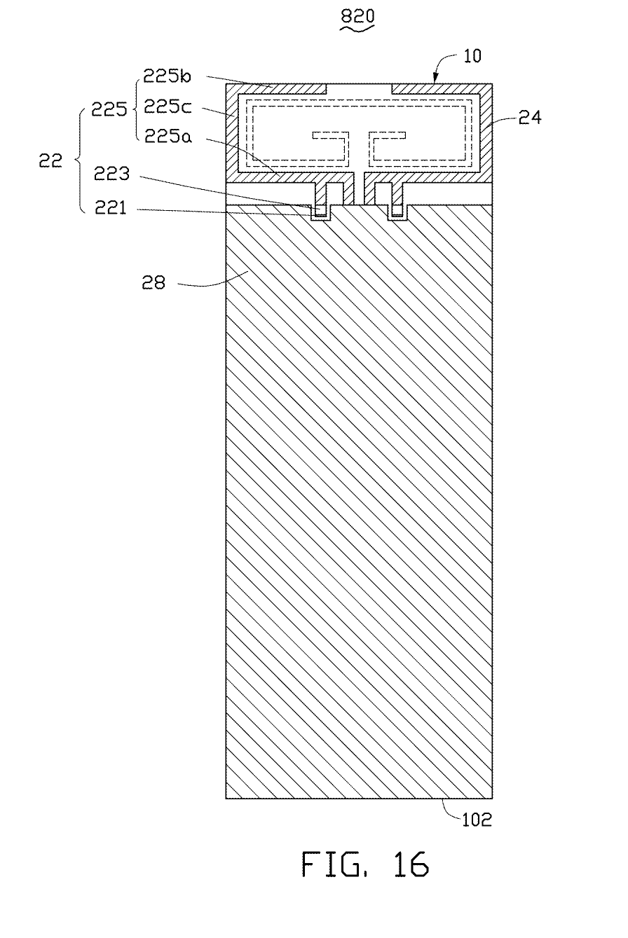

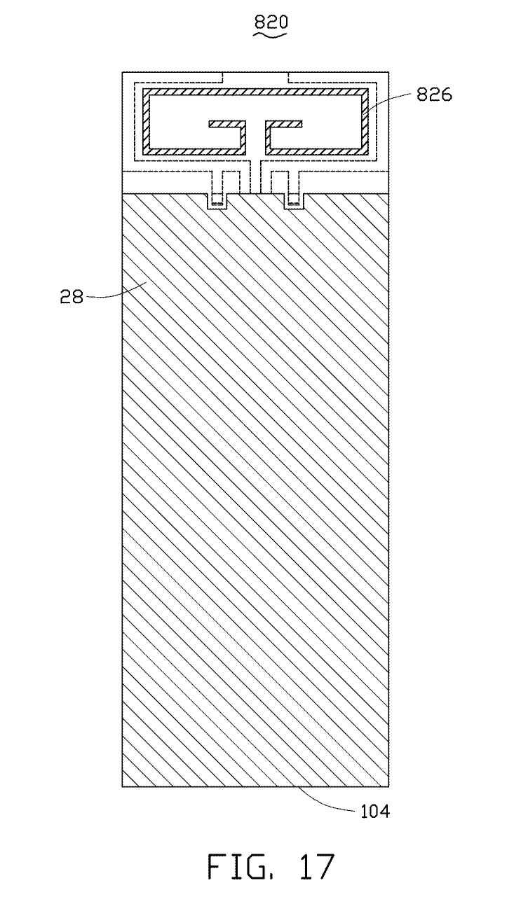

FIGS. 16 and 17 respectively show a front view and a back view of a fourth embodiment of a fourth MIMO antenna 820 in accordance with the present disclosure. The fourth MIMO antenna 820 includes a first antenna 22 and a second antenna 24 defined in axial symmetry, a fourth coupling portion 826 and a grounding portion 28. The first antenna 22 includes a feeding portion 221, a matching portion 223 and a radiating portion 225. The radiating portion 225 includes a first radiating part 225a, a second radiating part 225b and a third radiating part 225c. The first radiating part 225a, in the shape of a reversed “F”, includes a first open end, a second open end and a third open end. The first open end is electrically connected to the matching portion 223. The second open end is electrically connected to the grounding portion 28. The third open end is perpendicularly connected to the third radiating part 225c. The second radiating part 225b and the third radiating part 225c are elongated and perpendicularly connected to each other.

In the exemplary embodiment, the fourth coupling portion 826 of the fourth MIMO antenna 820 is located, on the second surface 104, between and separated from the first antenna 22 and the second antenna 24 to improve isolation of the fourth MIMO antenna 820. The fourth coupling portion 826 forms a meandering pattern and is about λ/2 in length, where the λ indicates wavelength of the electromagnetic signals. Therefore, a portion of currents of the first antenna 22 (or the second antenna 24) under a specific frequency is coupled to the fourth coupling portion 826 while resonance for the fourth coupling portion 826 is generated. Thus, currents on the second antenna 24 (or the first antenna 22) are greatly reduced to improve isolation of the fourth MIMO antenna 820.

In the exemplary embodiment, the fourth coupling portion 826 is defined in axial symmetry and share the same axis of symmetry with the first and second antennas 22 and 24.

In the exemplary embodiment, the fourth coupling portion 826 comprises an elongated strip with a first open end and a second open end. The elongated strip forms a rectangle with a gap defined at the center of one side of the rectangle. The first and second open ends inwardly extend from the gap to the inner of the rectangle in a first direction and then inwardly extend to the inner of the rectangle in a second direction. The first direction is parallel to the axis of symmetry of the fourth coupling portion 826 while the second direction is perpendicular to the axis of symmetry of the fourth coupling portion 826. The first open end and the second open end reversely extend in the second direction. The fourth coupling portion 826 is any type of meandering patterns and is λ/2 in length, where the λ is wavelength of the electromagnetic signals.

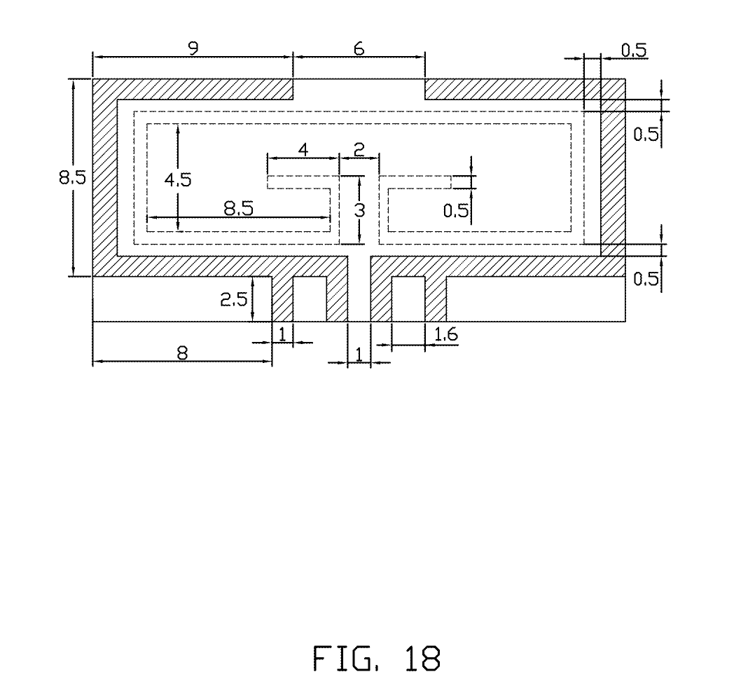

FIG. 18 shows a schematic view of exemplary dimensions of the radiating portion 225 and the fourth coupling portion 826 of the fourth MIMO antenna 820.

In the exemplary embodiment, the length and width of the first radiating part 225a are 13 mm and 1 mm, respectively. The length and width of the first radiating part 225b are 8 mm and 1 mm, respectively. The length and width of the first radiating part 225c are 8.5 mm and 1 mm, respectively. The length and width of the fourth coupling portion 826 are 62 mm and 0.5 mm, respectively.

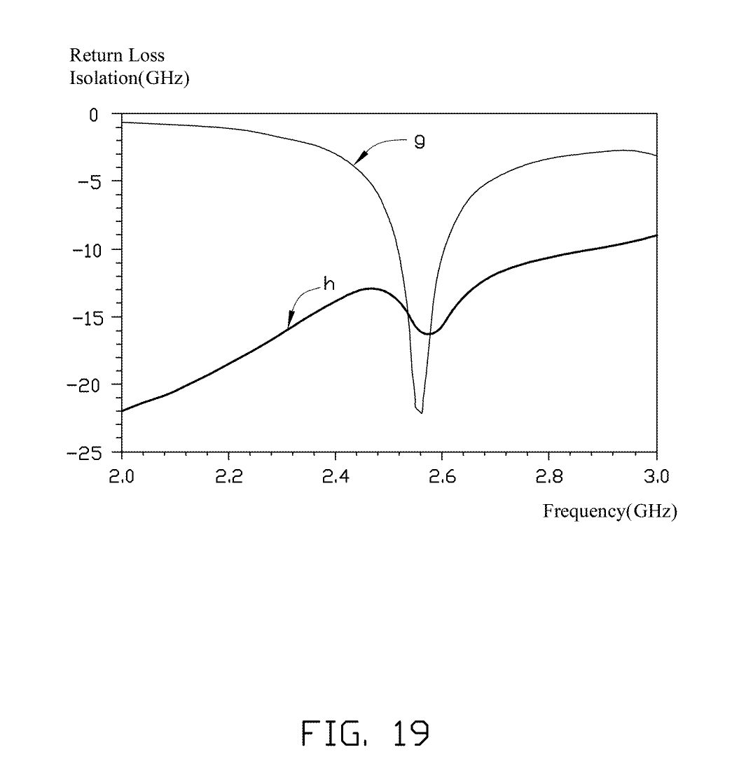

FIG. 19 shows exemplary return loss and isolation measurement for the fourth MIMO antenna 820. As shown in FIG. 19, curve g represents the return loss for the fourth MIMO antenna 820 while curve h represents the isolation for the fourth MIMO antenna 820. The present disclosure enables the fourth MIMO antenna 820 to cover radio frequency bands 2.5 GHz-2.6 GHz under LTE over which return loss attenuation is less than −10 decibels (dB), which is applicable to communication standards, provides better isolation and greatly ameliorates radiating performance of the fourth MIMO antenna 820.

As mentioned, the present disclosure defines a length of the radiating portion 225 of a MIMO antenna as about λ/4 and defines a length of each of the first coupling portion 26, the second coupling portion 426, the third coupling portion 626 and the fourth coupling portion 826 of the MIMO antenna as about λ/2. Thus, antenna isolation is meliorated to enhance radiating performance of the MIMO antenna.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A multiple-input multiple-output (MIMO) antenna located on a substrate, wherein the substrate comprises a first surface and a second surface opposite to the first surface and the MIMO antenna comprises a first antenna and a second antenna defined in axial symmetry, a coupling portion and a grounding portion, each of the first antenna and the second antenna comprising:
a feeding portion located on the first surface and operable to receive and feed electromagnetic wave signals to the antenna; and
a radiating portion located on the first surface, operable to radiate the electromagnetic signals from the feeding portion, wherein the radiation portion is in a meandering “S” pattern, and wherein the radiating portion is λ/4 in length where the λ indicates wavelength of the electromagnetic signals;
wherein the coupling portion is located between the first antenna and the second antenna and is λ/2 in length.

2. The MIMO antenna as claimed in claim 1, wherein each of the first antenna and the second antenna further comprises a matching portion, located on the first surface and electrically connected to the feeding portion and the radiating portion, wherein the matching portion implements impedance matching between the feeding portion and the radiating portion.

3. The MIMO antenna as claimed in claim 1, wherein the radiating portion comprises a first radiating part, a second radiating part and an elongated third radiating part, wherein each of the first radiating part and the second radiating part has an “L” shape, one end of the first radiating part is electrically connected to the matching portion while the other end is perpendicularly connected to the third radiating part.

4. The MIMO antenna as claimed in claim 3, wherein the second radiating part is perpendicularly connected to the third radiating part, and each of the first radiating part and the second radiating part is formed in crooked patterns.

5. The MIMO antenna as claimed in claim 1, wherein the coupling portion is separated from the first and second antennas and is defined in axial symmetry.

6. The MIMO antenna as claimed in claim 5, wherein the coupling portion shares the same axis of symmetry with the first and second antennas.

7. The MIMO antenna as claimed in claim 6, wherein the coupling portion comprises an elongated strip with a first open end and a second open end, wherein the elongated strip forms a rectangle with a gap defined at the center of one side of the rectangle while the first and second open ends inwardly extends from the gap to the inner of the rectangle, wherein the extended direction is parallel to the axis of symmetry of the coupling portion.

8. The MIMO antenna as claimed in claim 6, wherein the coupling portion comprises an elongated strip with a first open end and a second open end, wherein the elongated strip forms a rectangle with a gap defined at the center of one side of the rectangle while the first and second open ends outwardly extends from the gap to the outer of the rectangle, wherein the extended direction is parallel to the axis of symmetry of the coupling portion.

9. The MIMO antenna as claimed in claim 6, wherein the coupling portion comprises an elongated strip with a first open end and a second open end, wherein the elongated strip forms a rectangle with a gap defined at the center of one side of the rectangle and the first and second open ends outwardly extend from the gap to the outer of the rectangle in a first direction and then outwardly extends in a second direction, wherein the first direction is parallel to the axis of symmetry of the coupling portion while the second direction is perpendicular to the axis of symmetry of the coupling portion.

10. The MIMO antenna as claimed in claim 6, wherein the coupling portion comprises an elongated strip with a first open end and a second open end, wherein the elongated strip forms a rectangle with a gap defined at the center of one side of the rectangle and the first and second open ends inwardly extends from the gap to the inner of the rectangle in a first direction and then inwardly extends to the inner of the rectangle in a second direction, wherein the first direction is parallel to the axis of symmetry of the coupling portion while the second direction is perpendicular to the axis of symmetry of the coupling portion, wherein the two open ends reversely extend in the second direction.
